(19) United States
(12) Patent Application Publication
(10) Pub. No.: US 2004/0068936 A1
(43) Pub. Date: Apr. 15, 2004

(54) Prefabricated slatted closure

(76) Inventor: Hossein Amin-Javaheri, Houston, TX (US)

Correspondence Address: PHILIP ROZIERE, BOX 680, 47 KINGSCREST DR., LA SALLE, MB, ROG 1BO, CA

(21) Appl. No.: 10/268,734

(22) Filed: Oct. 10, 2002

(51) Int. Cl. E06B 7/08

(52) U.S. Cl. 49/74.1; 49/73.1; 49/87.1; 49/90.1

(57) ABSTRACT

A slatted closure, such as a shutter or bi-fold door, comprising a plurality of slats to cover the interior of the closure, two slat retainers to hold the slats in a prefabricated assembly, two vertical stiles and at least two horizontal rails, with each vertical stile having a channel formed along one side edge of the stile to receive and hold the prefabricated assembly of slats and slat retainers and the horizontal rails. The slats can either be fixed in place or movable to allow opening and closing of the slats.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The invention is relates to construction of and a method of constructing a closure. More specifically it relates to the improved construction of a slatted shutter or bi-fold door that allows the closure to be easily cut to fit the space.

2. Description of the Related Art

Closures, particularly shutters and bi-fold doors are well known in the art. Various methods have been used to construct these closures. However, a disadvantage of these closures has been the inability to quickly and easily adjust the size of the closure to match the user's requirements. Much of the prior art has been directed at adjustable length shutters, that is, shutters that can be adjusted to a particular height and/or width to fit the customer's requirements. However, one problem with many adjustable length assemblies is that complex trimming or cutting operations were required to adjust the length of the shutters. More importantly, in the case of slatted closures, the labor is extremely intensive because the individual slats must be reinserted into the stiles after the slats and stiles have been cut to fit.

U.S. Pat. No. 4,765,110 (MacLeod) discloses an adjustable shutter assembly of molded plastic construction whereby at least one shutter panel with a panel body and flat parallel runners which project from the panel body are slidably received by a pair of side rails with double channel tracks. Upper and lower end rails also possess flat parallel runners to slide into the corresponding track of the side rails.

U.S. Pat. No. 4,251,966 (Foltman) discloses a shutter comprised of a pair of side rails with respective single-channel tracks. Louvered panels are injection molded with integral side runners which slide into the tracks. Upper and lower cross pieces are fastened to the side rails by fasteners to hold the panels in place. The pieces are pre-coated to filter prevent exposure to ultraviolet radiation thereby preventing fading and deterioration.

Another disadvantage has been that often, the various components of these closures were somewhat difficult to manufacture and assemble which added to the cost of the closure. Therefore, there have been closures in the art that have addressed this issue. U.S. Pat. No. 3,983,674 (Yamamoto et al.) discloses a shutter panel assembly that consists of several prefabricated parts that could be assembled without the use of screws, rivets, bolts, or other fastening elements. However, there remains a need in the industry for a prefabricated slatted closure that can be easily and efficiently tailored to the dimensions that the end user needs.

### SUMMARY OF THE INVENTION

The present invention addresses the above disadvantages by providing a slatted closure and a method of constructing the slatted closure that comprises stiles, rails, slats and slat retainers. The slats and slat retainers are prefabricated as a unit that can be quickly adjusted prior to assembly to fit the user's requirements.

The present invention comprises a novel construction for a slatted closure, such as shutters and bi-fold doors, whereby the closure is made from a prefabricated slat and slat retainer assembly that can be trimmed to the proper length without removing the slats. This invention applies both to fixed slatted closures, such as bi-fold doors and to movable slatted closures, such as louvered shutters. In this invention, the prefabricated slats and slat retainer assembly is trimmed and inserted into two channeled stiles designed to receive the slat retainers. Preferably, the slat retainers and stiles mate in a dovetail fashion to securely hold the slat retainers in place. A top and bottom rail are also inserted into the channeled stiles to cap the slat retainers and hold them firmly in place. Optionally, a middle rail can be inserted between two prefabricated assemblies to provide support for hardware. The final assembly is a rectangular frame formed by the assembly of prefabricated parts that greatly reduces the amount of time and labor needed to properly fit the closure to the opening.

### BRIEF DESCRIPTION OF THE DRAWINGS

FIG. 1 is a front view of a fixed slatted embodiment of the closure assembly of the present invention.

FIG. 2 is a front view of a single panel of FIG. 1.

FIG. 3 is a top cross-sectional view of a vertical stile showing a side edge channel.

FIG. 4 is a perspective view of a slat retainer.

FIG. 5 is a perspective view of a pin.

FIG. 6 is a side cross-sectional view of a slat retainer.

FIG. 7 is a side cross-sectional view of a slat and slat retainer assembly.

FIG. 8 is a side cross-sectional view of a horizontal rail.

FIG. 9 is a perspective view of a rail with a mating plug.

FIG. 10 shows a first horizontal rail mating with the vertical stiles.

FIG. 11 shows a slat and slat assembly being inserted into the channel of the vertical stiles.

FIG. 12 shows a second horizontal rail mating with the vertical stiles to complete the construction.

FIG. 13 is a perspective view of a finished movable slatted embodiment of the present invention.

### DETAILED DESCRIPTION OF INVENTION

The essential components of this invention are slats, slat retainers to hold the slats in a prefabricated position, channeled stiles to receive the slat retainers, and rails to hold the slat retainers and stiles in place. Slat retainers hold the slats in a prefabricated assembly and permit the length to be trimmed without removing the slats. The basic components of the slatted closure consist of two vertical stiles, a plurality of slats, two slat retainers, and a top and bottom horizontal rail. Optionally, a middle rail can be added for decoration or to support hardware, such as a door knob. Each stile has a channel formed along the inside edge of the stile. This channel is designed to receive and hold one end of the horizontal rails and a slat retainer. Preferably the cross-section of the channel is a dovetail shape to permit sliding insertion of the slat retainers and horizontal rails and to securely hold the slat retainers and horizontal rails in place, although other shapes, such as a T-shape, will obviously work. Each horizontal rail is also mated with the channel at the top and bottom of the stiles to form a rigid frame. The slats may be either fixed or mounted to rotate in unison by means of a handle assembly. Such assemblies are well known in the art.

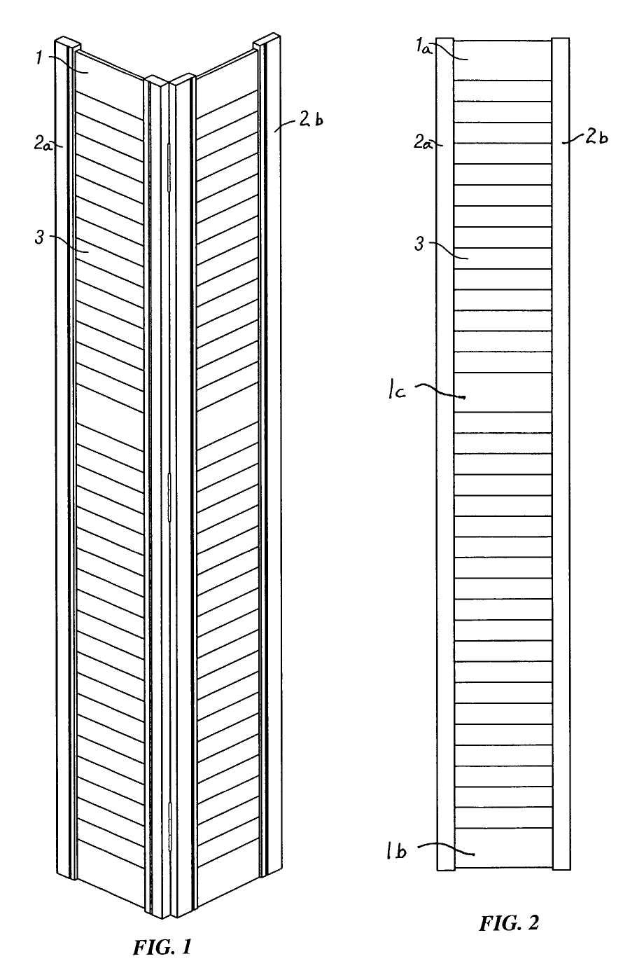

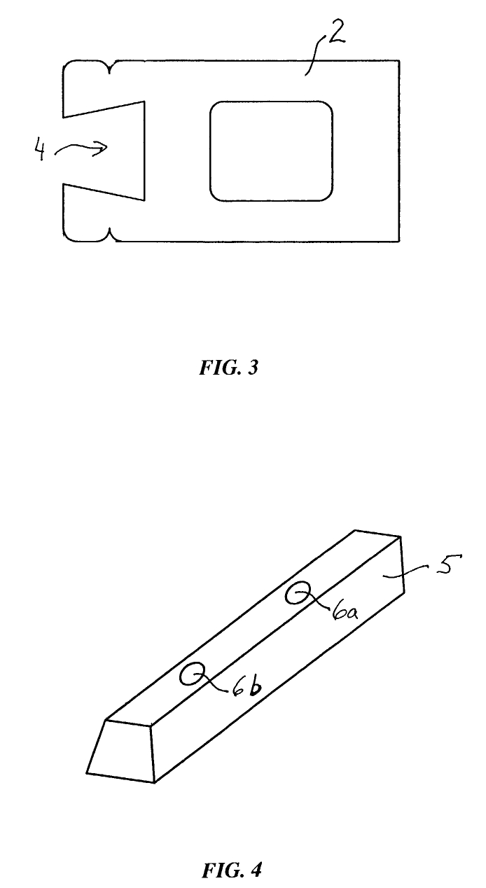

FIG. 1 shows a fixed slatted bi-fold door constructed in accordance with the present invention. The FIG. 2 is a single panel of FIG. 1. Generally, FIG. 2 is a rectangular frame formed by two vertical stiles 2a, 2b and two horizontal rails 1a, 1b. A plurality of slats 3 extend horizontally across the frame interior substantially from one vertical stile 2a, to the other vertical stile 2b. The slats 3 are generally flat. FIG. 3 shows the top cross-sectional view of the preferred embodiment of the stiles. As shown in FIG. 3, the stiles have a channel 4 that extends along one side edge.

FIG. 4 shows a section of slat retainer 5 designed to receive a plurality of slats. In application, two slat retainers 5 hold the slats in place during assembly and are inserted into channel 4 of the stiles. As noted in FIG. 3 and FIG. 4, the shape of the channel 4 and slat retainer 5 is preferably dovetail to allow the slat retainers 5 to mate with the stiles 2 and to be firmly held in place after assembly.

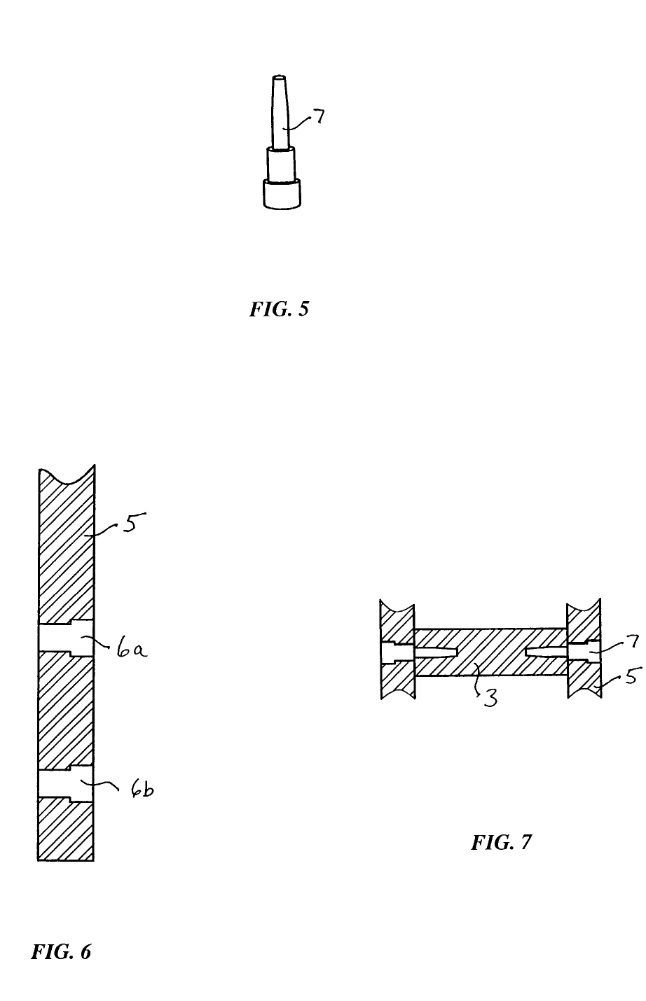

In the preferred embodiment shown in FIG. 5 and FIG. 6, each slat retainer 5 has a plurality of spaced holes 6a, 6b to receive a pin 7. As shown in FIG. 7, pin 7 engages one end of each slat 3 through a hole in the side edge of the slat (not shown). In the preferred embodiment for movable shutters, slats 3 rotate about their longitudinal axes to move from an open position to a closed position. FIG. 6 is a cross-section of the slat retainer 5 and shows holes 6a, 6b that will receive pin 7 during assembly. This pin 7 protrudes through the slat retainer 5 into the side of the slat 3 for a short distance, as shown in FIG. 7. This arrangement allows the slat 3 to rotate about the axis of the pin 7. It is the assembly of FIG. 7 that ultimately mates with the stiles 2 to form the interior of the closure.

Since tension on movable slats is desirable to allow the slats to be held in a variety of positions, it is preferred to have a tension mechanism, such as a spring (not shown), on the pin between the slat and the slat retainer. Of course, there are a variety of other possible embodiments. For example, the slat retainer can be made with such pins being an integral part of the construction, or the slats can be made with protrusions for insertion into holds in the slat retainer. The preferred embodiment of this invention, however, lends itself to mass production of the components in an extrusion process.

For fixed slatted closures, such as bi-fold doors, each slat retainer 5 can be configured to hold the slats in a fixed position. For example, in the preferred embodiment, instead of having one hole on each side of the slat which would allow for rotation, the slat retainer can be fitted with two holes for each side of the slat which would effectively hold the slats in a stationary position. As in the movable embodiment, each pair of holes would receive a pin that extends for a short distance into the side of the slat. Another possible method would be to use a non-cylindrical pin as the mechanism to hold the slat. One non-cylindrical pin on each side of the slat would effectively prevent the slat from rotating. Of course, other methods may be employed to hold the slats in a fixed position. For example, the slat itself may extend into a mating slot in the slat retainer. This embodiment eliminates the need for a pin to hold the slat stationary but does require precise dimensioning to hold the slats securely. Here again, the preferred embodiment lends itself to the extrusion process and minimizes the number of different components that need to be manufactured because the same pin could be used for both fixed and movable slat construction.

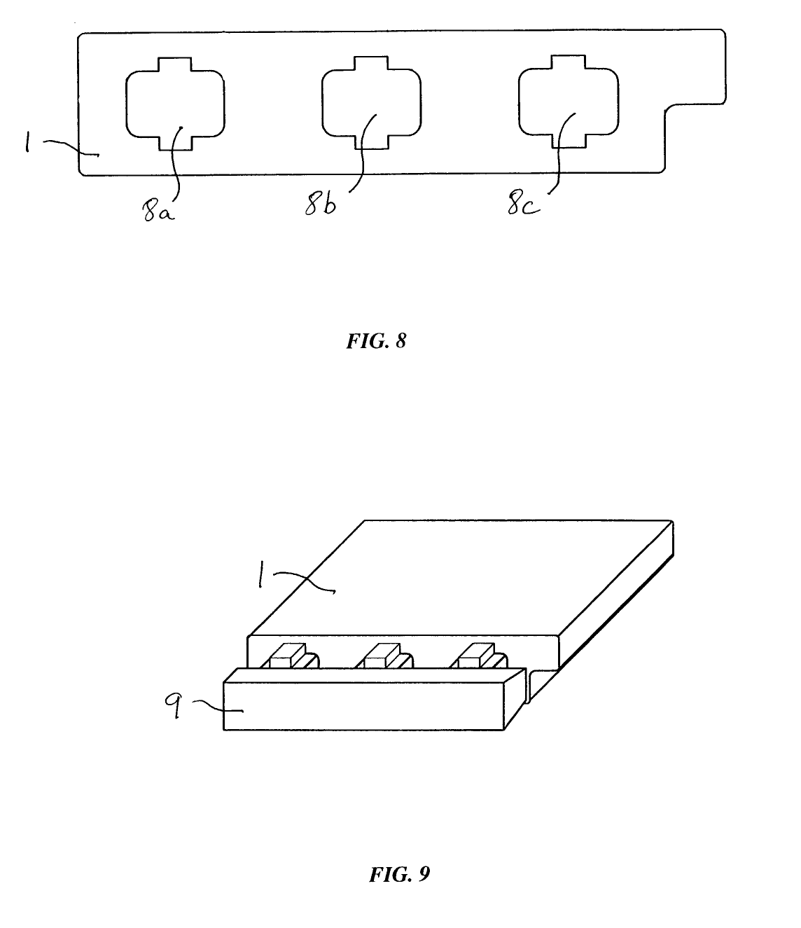

In the preferred embodiment, the manufacturer prefabricates the slat retainers to a standard length (for example, eight to twelve feet) and inserts the slats before shipping the assembly to the fabricator. The stiles and rails are also fabricated to a given length for shipping to the fabricator. Once the fabricator determines the desired height of the closure, he cuts the stiles to fit, and trims the slat retainers for insertion into the channel on the stile without ever having to remove the slats. Obviously, the fabricator must take into account the height of the top and bottom rails when trimming the slat retainer. Furthermore, the height of the rails can also be adjusted to allow for minor corrections to the overall height of the closure. For example, rails can be manufactured in different heights, such as 2 to 4 inches with 1/8 inch intervals, or simply can be trimmed with a saw. Thus, for example, a fabricator needing a closure that is exactly 36½ inches high can cut the slat assembly to a length of 30 inches and use two rails of 3¼ inches each to achieve the perfect fit. Furthermore, since the rails need to mate with the channel on the stiles after being cut to the proper length, it is preferable to design the rail with the ability to receive an assembly that can perform the mating function. For example, as illustrated in FIG. 8, rail 1 is extruded with openings 8a, 8b, 8c that run the length of the rail. As shown in FIG. 9, no matter where rail 1 is cut, these openings 8 can receive a plug 9 that will be securely attached to the rail, e.g., glued, and will have the proper cross-sectional shape for mating with the stiles 2.

Obviously, the fabricator also needs to take into account the width of the opening to be covered. To accommodate the varying width of the closure, the slats are manufactured in a variety of widths and prefabricated with the slat retainers before shipping to the fabricator. Typically, 6 inches through 36 inches per panel in one-inch intervals will suit every application. Furthermore, the stiles can also be manufactured in various widths to accommodate minor variations in the width of the opening. Typically, 1 inch through 3 inches with 1/8 inch intervals. For example, if the closure needs to be 22½inches wide, the fabricator will use a slat assembly that is 20 inches wide and two stiles that are each 1¼ inches wide.

By matching the proper prefabricated slat assembly with the proper width stile, the fabricator can quickly and easily customize the closure to fit any width opening and can trim the length of the assembly to fit any length opening. This prefabricated assembly greatly reduces the time that the fabricator spends assembling the closure from hours to minutes.

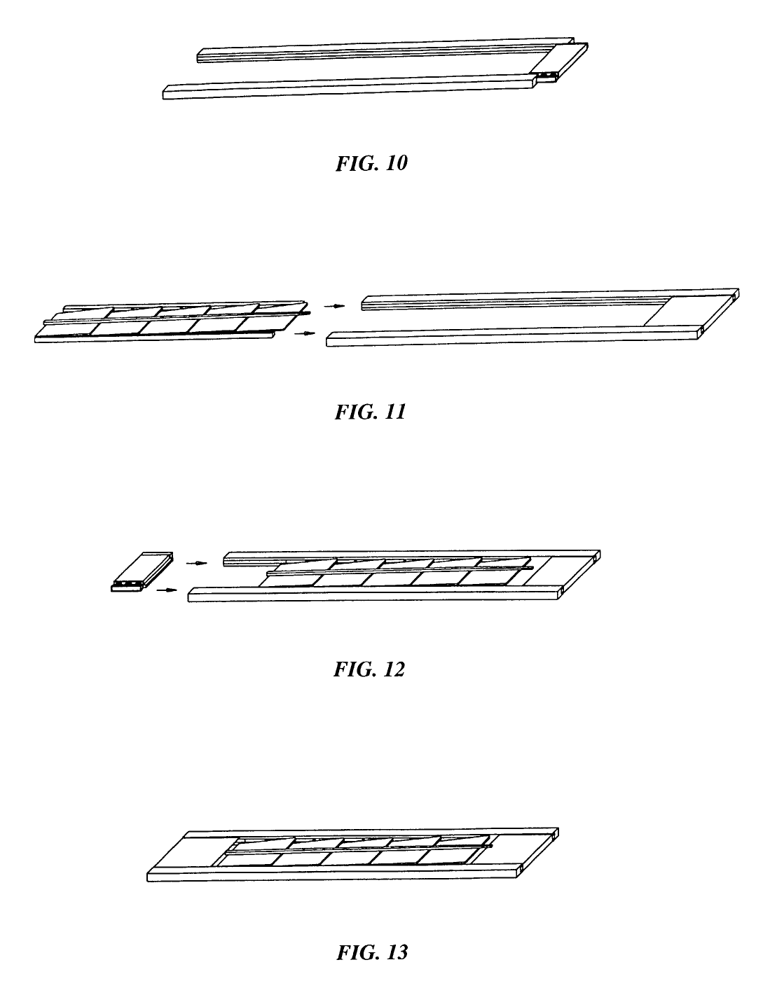

The preferred method of assembly is to insert one rail into both stiles to form three sides of the closure, as shown in FIG. 10. Next, the trimmed slat assembly is inserted along the channel through the open end of the closure, as illustrated in FIG. 11. Finally, the second rail is inserted into open end of the closure to securely hold the slat and slat retainers in place, as shown in FIG. 12. Alternatively, as shown in FIG. 2 a third rail 1c can be inserted between two slat assemblies. This third rail can be for decorative purposes or can accommodate hardware, such as a knob for physically moving the closure. The first and second rails are held in place by any commonly used means, such as, for example, screws, nails or glue. If a removable fastener is used to secure the rails, the closure can be disassembled to permit quick and easy repairs to the closure. For example, if broken slats cannot be replaced individually, the fabricator can simply cut a new slat assembly to the proper length, remove one of the rails, slide out the damaged assembly, and easily replace it with the new assembly. FIG. 13 shows a finished panel for a movable slatted closure. Such panels are usually hinged together to form a shutter.

The closure can be made of any suitable material such as wood, polyvinyl chloride (PVC), polystyrene, or preferably a wood/PVC composite. Preferably, the material is some type of resinous plastic because it is inexpensive and easily molded in an extrusion process. For example, the resinous plastic can be a foamed compound comprising about 50% to 75% polyvinyl chloride, about 1% to 30% wood powder, about 0.1% to 15% calcium carbonate, about 3% to 25% combination of stabilizer, lubricant, process aid, impact modifier, pigment, and titanium dioxide, and about 0.1% to 5% foaming agent. Most preferably, the compound is a foamed compound comprising about 70% to 75% polyvinyl chloride, about 5% to 10% wood powder, about 3% to 10% calcium carbonate, about 5% to 10% combination of a tin stabilizer (such as Elf Atochem's TM-181), a lubricant package (such as calcium stearate, Honeywell's A-C-629 oxidized polyethylene, and Allied Signal's XL-165 petroleum hydrocarbon paraffin wax), a process aid (such as Rohm & Haas's K-120), an impact modifier (such as Rohm & Haas's KM-334 or Elf Atochem's Durastrength D-200), pigment, and titanium dioxide, and about 0.3% to 2% foaming agent (such as Celogen AZRV).

Other embodiments of this invention will be apparent to those skilled in the art from a consideration of this specification or practice of the invention disclosed herein. Various omissions, modifications and changes to the principles described herein may be made by one skilled in the art without departing from the true scope and spirit of the invention which is indicated by the following claims.

What I claim is:

1. A slatted closure comprising:
two vertical stiles, wherein each stile has a channel formed along a side edge of the stile to receive a horizontal rail and a slat retainer;
two horizontal rails, wherein each rail mates with the channel at the top and bottom of each stile to form a frame;
a plurality of slats; and,
two slat retainers, wherein the slat retainers hold the plurality of slats in place and mate with the channel on each stile to cover the interior of the frame.

2. The closure of claim 1 wherein the slat retainers hold the plurality of slats in a fixed position.

3. The closure of claim 1 wherein the slat retainers hold the plurality of slats in a movable position.

4. The closure of claim 3 further comprising a handle on the plurality of slats for rotating the slats about the same angle of inclination.

5. The closure of claim 1 wherein the slats, stiles, rails and slat retainers are composed of a resinous plastic.

6. The closure of claim 5 wherein the resinous plastic comprises about 50% to 75% polyvinyl chloride, about 1% to 30% wood powder, about 0.1% to 15% calcium carbonate, about 3% to 25% combination of stabilizer, lubricant, process aid, impact modifier, pigment, and titanium dioxide, and about 0.1% to 5% foaming agent.

7. A method for assembling a closure that comprises two vertical stiles having a channel formed along a side edge of the stile to receive a horizontal rail and a slat retainer, two horizontal rails that mate with the channel at the top and bottom of the stiles to form a frame, an assembly of a plurality of slats held in place by two slat retainers, wherein the slat retainers mate with the channel of the stiles, the method comprising:
trimming the assembly to the desired length;
cutting the vertical stiles to the desired length;
cutting the horizontal rails to the desired length;
inserting the trimmed assembly into the channel on each stile; and,
inserting the mating ends of the horizontal rails into the channel on each stile to complete the closure.

8. The method of claim 7 further comprising inserting a first trimmed assembly into the channel on each stile, inserting a third rail into the channel on each stile, and inserting a second trimmed assembly into the channel on each stile.

9. The method of claim 7 wherein the mating end of one rail is inserted into the channel on each stile to form three sides of the frame, the trimmed assembly is inserted into the channel on each stile, and the second rail is inserted into the channel on each stile to complete the closure.

10. The method of claim 9 further comprising inserting a first trimmed assembly into the channel on each stile, inserting a third rail into the channel on each stile, and inserting a second trimmed assembly into the channel on each stile.
